(19) United States
(12) Patent Application Publication
(10) Pub. No.: US 2026/0331730 A1
(43) Pub. Date: Oct. 22, 2026

(54) ELECTRODE AND SECONDARY BATTERY INCLUDING ELECTRODE

(71) Applicant: SAMSUNG SDI CO., LTD., Yongin-si (KR)

(72) Inventors: Dong Bok YANG, Yongin-si (KR); Cheonsoo KIM, Yongin-si (KR); Junghyun LEE, Yongin-si (KR); Jeongyi PARK, Yongin-si (KR); Hyemin PARK, Yongin-si (KR); Giwook LEE, Yongin-si (KR)

(21) Appl. No.: 19/468,410

(22) Filed: Feb. 3, 2026

(30) Foreign Application Priority Data
Feb. 20, 2025 (KR) 10-2025-0022464

(51) Int. Cl. H01M 50/586; H01M 4/02; H01M 4/04; H01M 10/42

(52) U.S. Cl. CPC H01M 50/586; H01M 4/0404; H01M 10/4235; H01M 2004/021

(57) ABSTRACT

An electrode and a secondary battery including the electrode. The electrode includes a substrate, a first composite layer comprising an active material and disposed on a part of one surface of the substrate, and a first colored insulating layer having a color different from the substrate and covers each end portion of the first composite layer.

### CROSS-REFERENCE TO RELATED APPLICATION

This application claims priority to and the benefit of Korean Patent Application No. 10-2025-0022464, filed on Feb. 20, 2025, in the Korean Intellectual Property Office, the entire disclosure of which is incorporated herein by reference.

### BACKGROUND

### 1. Field

The present disclosure relates to an electrode and a secondary battery including the electrode.

### 2. Description of Related Art

While primary batteries are not designed to be (re)charged, secondary (also known as rechargeable) batteries are batteries that are designed to be discharged and recharged. Among secondary batteries, low-capacity secondary batteries are widely used in portable, small electronic devices, such as smart phones, feature phones, notebook computers, digital cameras, and camcorders, while high-capacity secondary batteries are widely used as power sources for driving motors in hybrid vehicles and electric vehicles, as well as for storing power (e.g., home and/or utility scale power storage). A secondary battery generally includes an electrode assembly including a positive electrode and a negative electrode, a case accommodating both electrodes, and electrode terminals connected to the electrode assembly.

An electrode assembly may have a stacked structure or a wound structure, both of which having a separator placed between a positive electrode and a negative electrode.

As the secondary battery charges or discharges, lithium ions may pass through a separator and move from a positive electrode to a negative electrode, or from a negative electrode to a positive electrode. While the lithium ions move, the positive and negative electrodes may expand or contract, and the rate of expansion or contraction of the positive electrode may be different from that of the negative electrode. To balance the difference of the positive and negative electrodes, one electrode may have an area less than that of the other electrode.

When one electrode (e.g., a positive electrode) has an area less than that of the other electrode (e.g., a negative electrode), short-circuits may occur between the positive electrode and the negative electrode that face each other. To prevent short-circuits, an insulating layer may be provided at both ends of a composite layer formed by applying an active material layer on the substrate of an electrode.

This Background section is for the general understanding of the background of the present disclosure, and therefore, it may contain information that does not constitute related (or prior) art.

### SUMMARY

The present disclosure provides an electrode and a secondary battery including the electrode.

According to embodiments of the present disclosure, an electrode includes a substrate, at least one first composite layer including an active material and formed on a part of one surface of the substrate, and a first colored insulating layer having a different color from the substrate and configured to cover each of end portions of the at least one first composite layer.

Embodiments of the present disclosure provide an electrode including a substrate, a first composite layer comprising an active material and disposed on a part of one surface of the substrate, and a first colored insulating layer having a color different from the substrate and covers each end portion of the first composite layer.

In some embodiments, the at least one first composite layer and the first colored insulating layer may be formed on the substrate simultaneously.

In some embodiments, the first colored insulating layer may include a first area configured to cover from an end portion of the at least one first composite layer to a part of the at least one first composite layer, and a second area configured to cover from the end portion of the at least one first composite layer to a part of one surface of the substrate.

In some embodiments, the first colored insulating layer includes: a first area covering from the end portion to a part of the first composite layer; and a second area covering from the end portion to the part of the one surface of the substrate.

In some embodiments, a length of the second area may be greater than about 0.5 mm.

In some embodiments, a thickness of the first colored insulating layer may be greater than about 5 μm.

In some embodiments, the electrode may further include at least one second composite layer including an active material and formed on a part of the other surface of the substrate, and a second colored insulating layer having a color different from the substrate, and configured to cover each of both end portions of the at least one second composite layer.

In some embodiments, the electrode further includes: a second composite layer including the active material and disposed on a part of the other surface of the substrate; and a second colored insulating layer having a color different from the substrate and covers each end portions of the second composite layer.

In some embodiments, the first colored insulating layer may include a ceramic, a binder, or a pigment.

In some embodiments, the ceramic may include boehmite or alumina.

In some embodiments, the binder may include at least one of Polyvinylidene fluoride (PVDF), Styrene Butadien Rubber (SBR), Acryl, Polyamide (PA), Poly Amide Imide (PAI), or Co-polymer.

In some embodiments, the binder includes polyvinylidene fluoride, styrene butadiene rubber, acryl, polyamide, polyamideimide, or a copolymer thereof.

In some embodiments, the pigment may include an organic pigment, an inorganic pigment, or a synthetic pigment.

In some embodiments, the at least one first composite layer may be continuously formed in a first direction that is a length direction of the substrate, and the first colored insulating layer may be continuously formed in the first direction from a left end portion and a right end portion of the at least one first composite layer, the end portions corresponding to each other in a second direction that is a width direction of the substrate and intersects the first direction.

In some embodiments, the first composite layer is continuous along a longitudinal direction of the substrate, and wherein the first colored insulating layer is continuous along the longitudinal direction at each of the end portions of the first composite layer relative to a lateral direction of the substrate.

In some embodiments, the at least one first composite layer may include a plurality of first composite layers with a predetermined distance on the substrate in the second direction.

In some embodiments, the first composite layer includes a plurality of first composite layers, and wherein each of the plurality of first composite layers are separated by a predetermined distance in the lateral direction.

In some embodiments, the at least one first composite layer may include a plurality of first composite layers with a predetermined distance in a first direction that is a length direction of the substrate, wherein the first colored insulating layer may be continuously formed in a second direction that is a width direction of the substrate and intersects the first direction, from an initial end and a terminal end of the at least one first composite layer, the ends corresponding to each other in the first direction.

In some embodiments, the first composite layer comprises a plurality of first composite layers, wherein each of the plurality of first composite layers are separated by a predetermined distance in the longitudinal direction.

In some embodiments, the first colored insulating layer is continuous along a lateral direction of the substrate from an initial end and a terminal end of the first composite layer relative to the longitudinal direction.

In some embodiments, the electrode may further include at least one second composite layer including an active material and formed on a part of the other surface of the substrate, and a second colored insulating layer having a different color from the substrate and configured to cover each of both end portions of the at least one second composite layer, wherein one of the first composite layer and the second composite layer is longer than the other one in the first direction.

In some embodiments, the electrode further includes: a second composite layer including the active material and disposed on a part of the other surface of the substrate; and a second colored insulating layer having a color different from the substrate and covers each end portions of the second composite layer, wherein the first composite layer and the second composite layer have different lengths in the longitudinal direction.

In some embodiments, one of the first colored insulating layer formed at the initial end and the first colored insulating layer formed at the terminal end of the at least one first composite layer may be longer than the other one in the first direction.

In some embodiments, the first colored insulating layer formed at the initial end and the first colored insulating layer formed at the terminal end have different lengths in the longitudinal direction.

In some embodiments, the first colored insulating layer may be continuously formed in the first direction between an initial end and an adjacent terminal end of the at least one first composite layer.

In some embodiments, the first colored insulating layer is continuous along in the longitudinal direction between the initial end of one of the first composite layer and the terminal end of the at least one first composite layer adjacent to the one of the first composite layer.

According to embodiments of the present disclosure, a secondary battery may include an electrode assembly including a first electrode, a separator, and a second electrode, a case configured to accommodate the electrode assembly, and a cap assembly coupled to an opening of the case to seal the case, wherein the first electrode includes a substrate, at least one first composite layer including an active material and formed on a part of one surface of the substrate, and a first colored insulating layer having a different color from the substrate and configured to cover each of both end portions of the at least one first composite layer.

Embodiments of the present disclosure provide a secondary battery including: an electrode assembly including a first electrode, a separator, and a second electrode; a case accommodating the electrode assembly; and a cap assembly coupled to an opening of the case, wherein the first electrode includes: a substrate; a first composite layer including an active material and disposed on a part of one surface of the substrate; and a first colored insulating layer having a color different from the substrate and covers each end portion of the first composite layer.

In some embodiments, the at least one first composite layer and the first colored insulating layer may be formed on the substrate simultaneously.

In some embodiments, the at least one first composite layer may be continuously formed in a first direction that is a length direction of the substrate, and the first colored insulating layer may be continuously formed in the first direction from a left end portion and a right end portion of the first composite layer, the end portions corresponding to each other in a second direction that is a width direction of the substrate and intersects the first direction.

In some embodiments, the first composite layer is continuous along a longitudinal direction of the substrate, and wherein the first colored insulating layer is continuous along the longitudinal direction at each of the end portions of the first composite layer relative to a lateral direction of the substrate.

In some embodiments, the at least one first composite layer may include a plurality of first composite layers with a predetermined distance in a first direction that is a length direction of the substrate, and the first colored insulating layer may be continuously formed in a second direction that is a width direction of the substrate and intersects the first direction, from an initial end and a terminal end of the first composite layer, the ends corresponding to each other in the first direction.

In some embodiments, the first composite layer comprises a plurality of first composite layers, and wherein each of the plurality of first composite layers are separated by a predetermined distance in the longitudinal direction.

In some embodiments, the first colored insulating layer is continuous along a lateral direction of the substrate from an initial end and a terminal end of the first composite layer relative to the longitudinal direction.

According to embodiments of the present disclosure, there is provided a colored insulating having a color different from a substrate.

According to embodiments of the present disclosure, in a vision test conducted after an electrode plate is manufactured, electrode plates without an insulating layer may be easily detected.

According to embodiments of the present disclosure, time and cost for manufacturing an electrode plate may be reduced by simultaneously forming a composite layer and a colored insulating layer on a substrate.

### BRIEF DESCRIPTION OF DRAWINGS

The drawings illustrate embodiments of the present disclosure, and further describe aspects and features of the present disclosure together with the detailed description of the present disclosure. Thus, the present disclosure should not be construed as being limited to the drawings.

FIG. 1 is a view illustrating an electrode according to embodiments of the present disclosure;

FIG. 2 is a cross-sectional view taken along A-A of FIG. 1;

FIG. 3 is a view illustrating an electrode including a plurality of composite layers with a predetermined distance in the lateral direction of a substrate according to embodiments of the present disclosure;

FIG. 4 is a view illustrating an electrode including a plurality of composite layers with a predetermined distance in the longitudinal direction of a substrate according to embodiments of the present disclosure;

FIG. 5 is a cross-sectional view taken along B-B of FIG. 4;

FIG. 6 is a view illustrating an electrode shown in FIG. 5;

FIG. 7 is a view illustrating an electrode shown in FIG. 4;

FIG. 8 is a cross-sectional view taken along C-C of FIG. 7;

FIG. 9 is a view illustrating an electrode shown in FIG. 4;

FIG. 10 is a cross-sectional view taken along D-D of FIG. 9;

FIG. 11 is a view showing a method for manufacturing an electrode including a plurality of composite layers with a predetermined distance in the lateral direction of a substrate according to embodiments of the present disclosure;

FIG. 12 is a view showing a method for manufacturing an electrode including a plurality of composite layers with a predetermined distance in the longitudinal direction of a substrate according to embodiments of the present disclosure;

FIG. 13 is a view illustrating a secondary battery according to embodiments of the present disclosure; and

FIG. 14 is an enlarged view of area E of FIG. 13.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

To facilitate understanding of the disclosure, the attached drawings are not drawn to actual scale and the dimensions of some components may be exaggerated. Furthermore, the same reference numbers may be assigned to the same components in different embodiments. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to be limiting of the present disclosure.

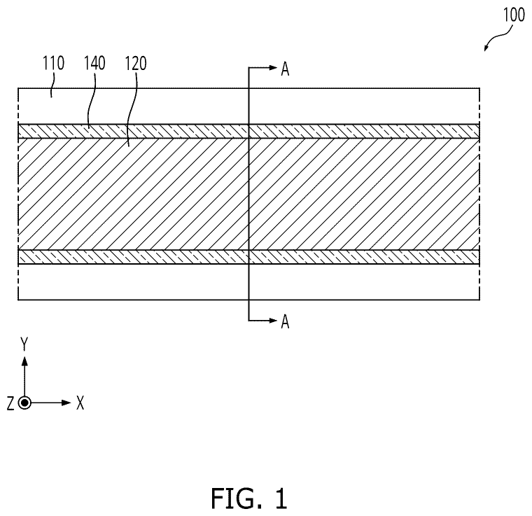

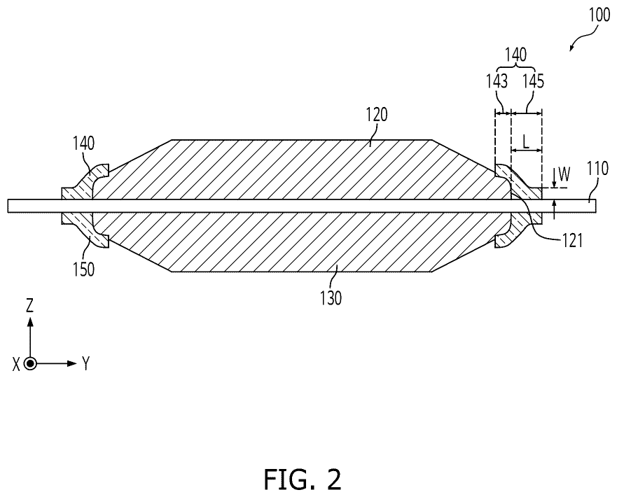

FIG. 1 is a view illustrating an electrode. FIG. 2 is a cross-sectional view taken along A-A of FIG. 1.

Referring to FIG. 1 and FIG. 2, an electrode 100 may function as a positive electrode of a secondary battery. The electrode 100 may refer to one electrode, or a plurality of electrodes.

The electrode 100 may include a substrate 110, at least one first composite layer 120 formed on a part of one surface of the substrate 110, and a first colored insulating layer 140 that covers each of both end portions of the first composite layer 120.

The electrode 100 may include at least one second composite layer 130 formed on a part of the other surface of the substrate 100, and a second colored insulating layer 150 that covers each of both end portions of the second composite layer 130.

The substrate 110 may be a current collector formed of a metal material in the form of a thin plate or a metal film. For example, the substrate 110 may be made of aluminum or aluminum alloy foil.

The first composite layer 120 and the first colored insulating layer 140 may be formed on one surface of the substrate 110, and the second composite layer 130 and the second colored insulating layer 150 may be formed on the other surface of the substrate 110, which is opposite to the one surface.

For example, after the first composite layer 120 and the first colored insulating layer 140 are coated and formed on one surface of the substrate 110, the second composite layer 130 and the second colored insulating layer 150 may be coated and formed on the other surface of the substrate 110. However, the present disclosure is not limited thereto, but after the second composite layer 130 and the second colored insulating layer 150 are formed on the other surface of the substrate 110, and then the first composite layer 120 and the first colored insulating layer 140 may be formed on the one surface of the substrate 110.

The first composite layer 120 may be formed on one surface of the substrate 110. The first composite layer 120 may be coated and formed on the one surface of the substrate 110. The first composite layer 120 may include an active material. For example, the first composite layer 120 may be made by applying an electrode composite including an active material, a binder, or a conductive material onto the surface of the substrate 100 followed by drying and rolling.

The first colored insulating layer 140 may cover both end portions of the first composite layer 120.

The first colored insulating layer 140 may include a first area 143 that covers from an end portion 121 of the first composite layer 120 to a part of the first composite layer 120, and a second area 145 that covers from the end portion 121 of the first composite layer 120 to a part of one side of the substrate 110. In the vertical direction of the substrate 110, the first area 143 of the first colored insulating layer 140 may overlap the first composite layer 120 and the substrate 110. The second area 145 of the first colored insulating layer 140 may overlap the substrate 110 in the vertical direction of the substrate 110.

A length L of the second area 145 of the first colored insulating layer 140 may be greater than about 0.5 mm, but the present disclosure is not limited thereto. A thickness W of the first colored insulating layer 140 may be greater than about 0.5 μm, but the present disclosure is not limited thereto.

The remaining portion of the one surface of the substrate 110, to which neither the first composite layer 120 nor the first colored insulating layer 140 is applied, may be referred to as a non-coated part. The non-coated part may be formed into an electrode tab through a slitting process and a notching process, but the present disclosure is not limited thereto.

The first composite layer 120 and the first colored insulating layer 140 may be formed simultaneously. In some embodiments, the first colored insulating layer 140 may be formed before or after the first composite layer 120. Forming the first composite layer 120 and the first colored insulating layer 140 simultaneously may indicate the formation of the first composite layer 120 and the first colored insulating layer 140 occurring with some temporal overlap. The initial point of forming the first colored insulating layer 140 may occur between the initial and end points of the formation of the first composite layer 120.

The first colored insulating layer 140 may include a ceramic, a binder, or a pigment. According to embodiments, the ceramic may include boehmite or alumina, but it is not limited thereto. The binder may include polyvinylidene fluoride (PVDF), styrene butadiene rubber (SBR), acrylic, polyamide (PA), polyamide imide (PAI), or a copolymer, but it is not limited thereto. According to embodiments, the pigment may include an organic pigment, an inorganic pigment, or a synthetic pigment, but it is not limited thereto.

The second composite layer 130 may be formed on the other surface of the substrate 110. The second composite layer 130 may be coated and formed on the other surface of the substrate 110. The second composite layer 130 may include an active material. For example, the second composite layer 130 may be made by applying an electrode composite including a binder, a conductive material, or an active material onto the surface of the substrate 110 followed by drying and rolling.

The second colored insulating layer 150 may be formed to cover both end portions of the first composite layer 120. The second composite layer 130 and the second colored insulating layer 150 may be formed simultaneously. In some embodiments, the second colored insulating layer 150 may be formed before or after the first composite layer 120.

The second colored insulating layer 150 may be formed with the material and composition ratio the same as the first colored insulating layer 140. However, the present disclosure is not limited thereto, the second colored insulating layer 150 may have a different material and/or composition ratio from the first colored insulating layer 140.

X-axis, Y-axis, and Z-axis directions shown in FIGS. 1 and 2 may refer to the longitudinal, lateral, and vertical directions of the substrate 110 or the electrode 100, respectively.

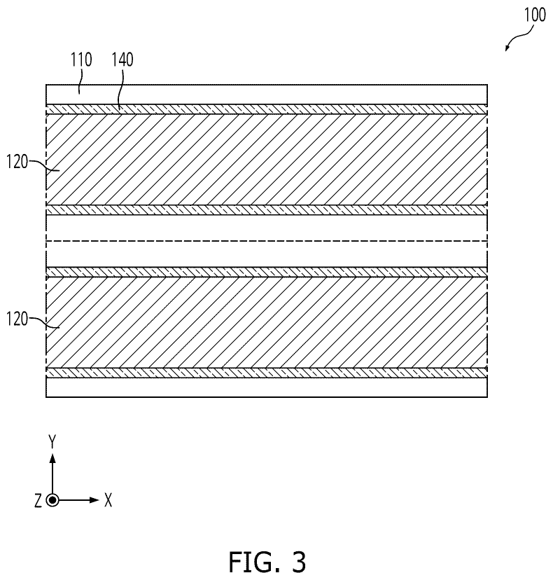

FIG. 3 is a view illustrating an electrode including a plurality of composite layers with a predetermined distance in the lateral direction of a substrate.

Referring to FIG. 3, the first composite layer 120 may be continuously formed in the first direction (e.g., X-axis direction), which is the longitudinal direction of the substrate 110.

The first composite layer 120 may include a plurality of first composite layers with a predetermined distance in the second direction (e.g., Y-axis direction), which is the lateral direction of the substrate 110 and intersects the first direction.

The first colored insulating layer 140 may be continuously formed in the first direction from left and right end portions of the first composite layer 120, the ends being disposed to correspond to each other in the second direction.

Although not shown in FIG. 3, the second composite layer 130 may be formed on the other surface of the substrate 110 that is opposite to the surface where the first composite layer 120 is formed. The second composite layer 130 may have a structure symmetrical to the first composite layer 120, but the present disclosure is not limited thereto.

Through a slitting process, the substrate 110 disposed between a plurality of first composite layers 120 may be cut in the first direction. Each cut substrate 110 along with the first composite layer 120, the first colored insulating layer 140, the second composite layer 130 (refer to FIG. 2), and the second colored insulating layer 150 (refer to FIG. 2) formed thereon may function as a single electrode.

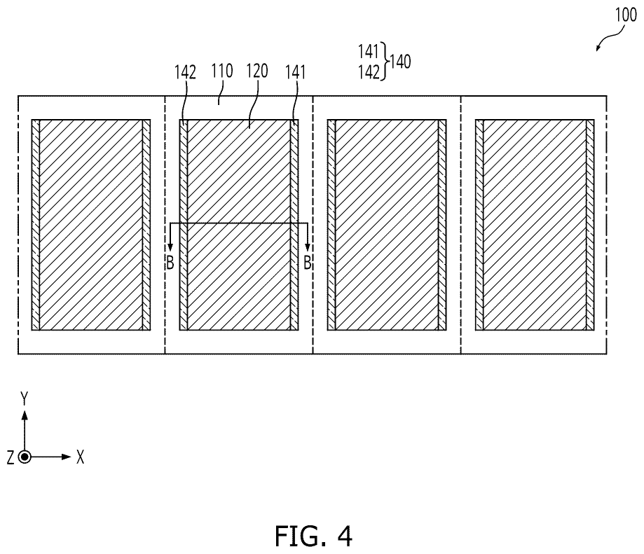

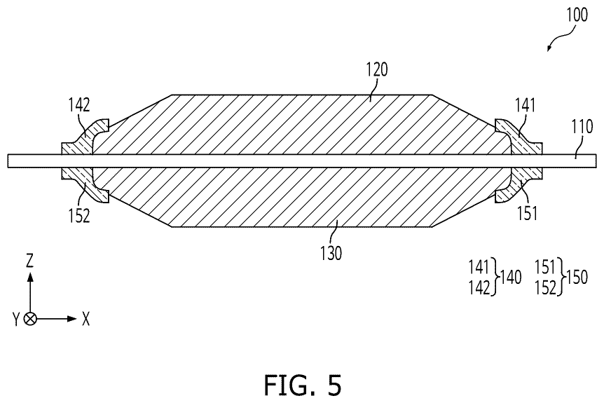

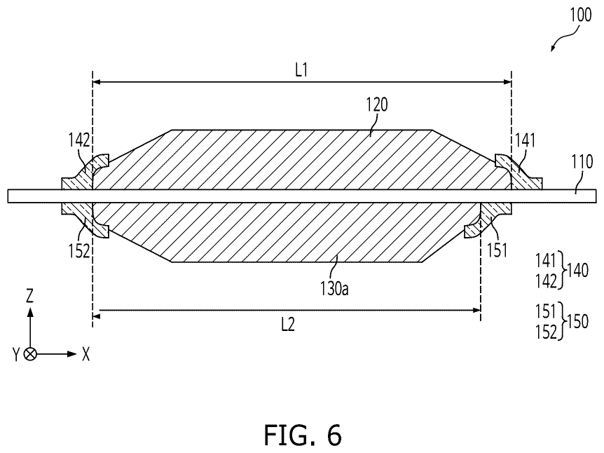

FIG. 4 is a view illustrating an electrode including a plurality of composite layers with a predetermined distance in the longitudinal direction of a substrate. FIG. 5 is a cross-sectional view taken along B-B of FIG. 4. FIG. 6 is a view illustrating an electrode shown in FIG. 5.

Referring to FIG. 4. and FIG. 5, the first composite layer 120 may include a plurality of first composite layers with a predetermined distance in the first direction (e.g., X-axis direction) in the length direction of the substrate 110.

The first colored insulating layer 140 may be continuously formed in the second direction (e.g., Y-axis direction), which is the lateral direction of the substrate and intersects the first direction, from the initial and terminal ends of the first composite layer 120, the ends being disposed to correspond to each other in the first direction.

A first colored insulating layer 141 formed at the initial end and a first colored insulating layer 142 formed at the terminal end may have the same length with the symmetrical structure.

The second composite layer 130 may be formed on the other surface opposite to one surface of the substrate 110 on which the first composite layer 120 is formed. The second composite layer 130 may have a structure symmetrical to the first composite layer 120 with respect to the substrate 110. The second colored insulating layer 150 may have a structure symmetrical to the first colored insulating layer 140 with respect to the substrate 110.

Referring to FIG. 6, one of the first composite layer 120 and a second composite layer 130a may be formed longer than the other in the first direction (e.g., X-axis direction), which is the longitudinal direction of the substrate 110. For example, on the substrate 110, a length L1 in the first direction of the first composite layer 120 may be greater than a length L2 in the first direction of the second composite layer 130. However, the present disclosure is not limited thereto.

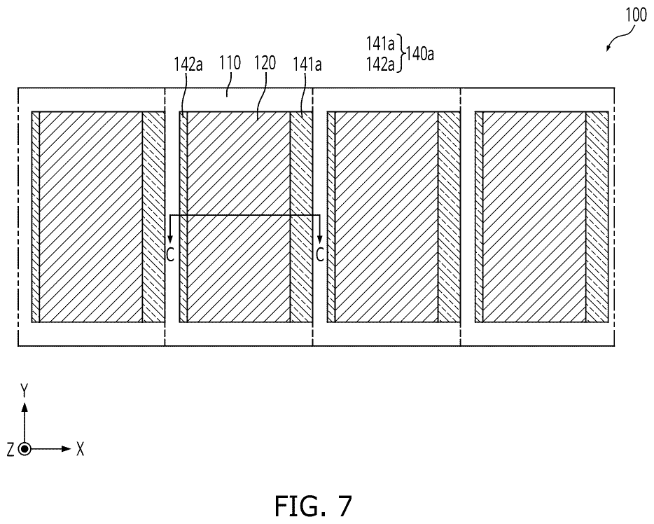

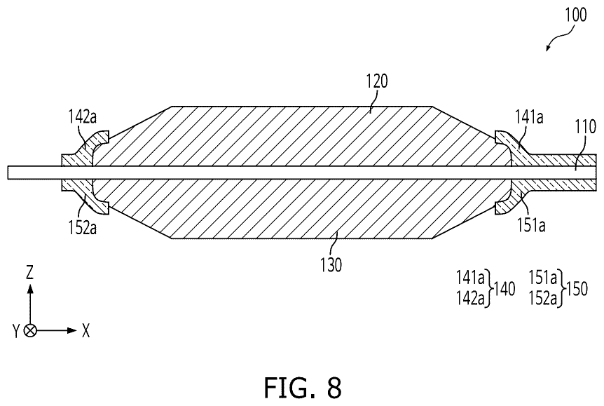

FIG. 7 is a view illustrating an electrode shown in FIG. 4. FIG. 8 is a cross-sectional view taken along C-C of FIG. 7.

Referring to FIG. 7 and FIG. 8, the first composite layer 120 may include a plurality of first composite layers with a predetermined distance in the first direction (e.g., X-axis direction), which is the longitudinal direction of the substrate 110.

A first colored insulating layer 140a may be continuously formed in the second direction (e.g., Y-axis direction), which is the lateral direction of the substrate that interests the first direction from the initial and terminal ends of the first composite layer 120, the ends being disposed to correspond to each other in the first direction.

One of a first colored insulating layer 141a formed at the initial end and a first colored insulating layer 142a formed at the terminal end may be greater than the other in the first direction. For example, the first colored insulating layer 141a formed at the initial end may be greater than a first colored insulating layer 142b formed at the terminal end in the first direction, but the present disclosure is not limited thereto.

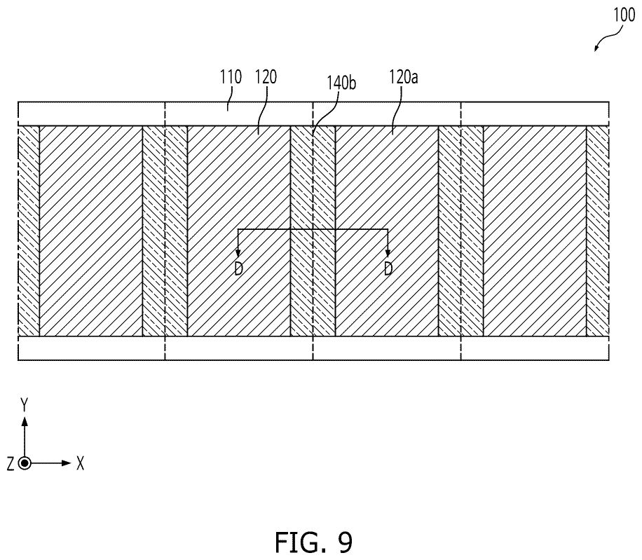

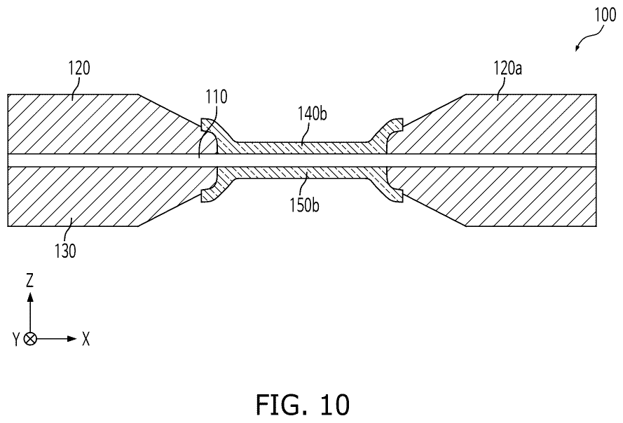

FIG. 9 is a view illustrating an electrode shown in FIG. 4. FIG. 10 is a cross-sectional view taken along D-D of FIG. 9.

Referring to FIG. 9 and FIG. 10, the first composite layer 120 may include a plurality of first composite layers with a predetermined distance in the first direction (e.g., X-axis direction), which is the longitudinal direction of the substrate 110.

A first colored insulating layer 140b may be continuously formed in the first direction from between the initial end and the adjacent terminal end of first composite layers 120 and 120a. For example, between the initial end of the first composite layer 120 and the terminal end of a first composite layer 120a, the first colored insulating layer 140b may be continuously formed in the first direction.

The second composite layer 130 may have a structure symmetrical to the first composite layers 120 and 120a with respect to the substrate 110. However, the present disclosure is not limited thereto. A second colored insulating layer 150b may have the structure symmetrical to the first colored insulating layer 140b with respect to the substrate 110. However, the present disclosure is not limited thereto.

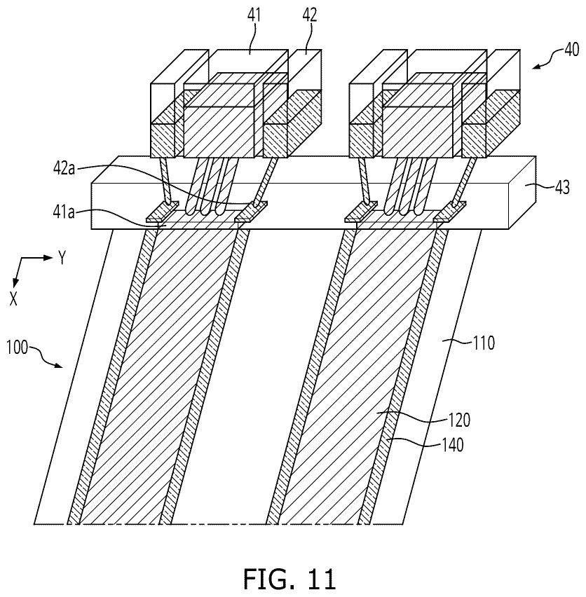

FIG. 11 is a view showing a method for manufacturing an electrode including a plurality of composite layers with a predetermined distance in the lateral direction of a substrate.

Referring to FIG. 11, a first coating device 40 may form the first composite layer 120 and the first colored insulating layer 140 on one surface of the substrate 110. The first composite layer 120 may include a plurality of first composite layers to extend in the first direction (e.g., X-axis direction), which is the longitudinal direction of the substrate, with a predetermined distance in the second direction (e.g., Y-axis direction), which is the lateral direction of the substrate. The first colored insulating layer 140 may be continuously formed in the first direction from left hand side and right hand side end portions of the first composite layer 120 that correspond to each other in the second direction (e.g., Y-axis direction), which is the lateral direction of the substrate and intersects the first direction.

The first coating device 40 may include at least one first chamber 41 that supplies a first slurry for forming the first composite layer 120, at least one second chamber 42 that supplies a second slurry for forming the first colored insulating layer 140, and a slot die 43 that simultaneously applies the first slurry and the second slurry on the substrate 110. The first slurry may include a positive electrode active material, a binder and/or a conductive material. The second slurry may include a ceramic, a binder, or a pigment. FIG. 11 illustrates that two of first chambers 41 and two of second chambers 42, but the present disclosure is not limited thereto.

The first coating device 40 may apply a first slurry onto the substrate 110 by pressurizing the first chamber 41 to form the first composite layer 120 on the substrate 110. Simultaneously, the first coating device 40 may apply a second slurry onto the substrate 110 by pressurizing the second chamber 42 to form the first colored insulating layer 140 on the substrate 110.

The slot die 43 may include a first nozzle 41a connected to the first chamber 41 to discharge the first slurry, and a second nozzle 42a connected to the second chamber 42 to discharge the second slurry. For example, the second nozzle 42a may be disposed to overlap both upper ends of the first nozzle 41a, and the first colored insulating layer 140 may be formed to cover each of both end portions of the first composite layer 120 by simultaneously discharging the first slurry and the second slurry on the substrate 110.

However, as described above, the method of forming the first composite layer 120 and the first colored insulating layer 140 simultaneously is only exemplary, but the present disclosure is not limited thereto.

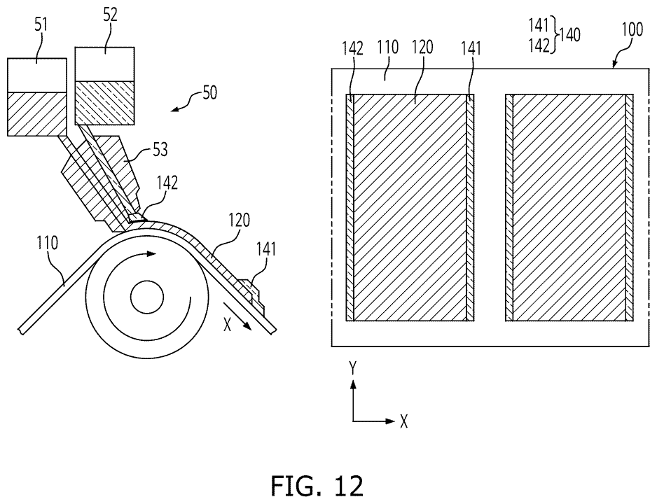

FIG. 12 is a view showing a method for manufacturing an electrode including a plurality of composite layers with a predetermined distance in the longitudinal direction of a substrate.

Referring to FIG. 12, a second coating device 50 may form the first composite layer 120 and the first colored insulating layer 140 on one surface of the substrate 110. The first composite layer 120 may include a plurality of first composite layers with a predetermined distance in the first direction (e.g., X-axis direction), which is the longitudinal direction of the substrate. The first colored insulating layer 140 may be continuously formed in the second direction (e.g., Y-axis direction), which is the lateral direction of the substrate and intersects the first direction, from the initial and terminal ends of the first composite layer that correspond to each other in the first direction.

The second coating device 50 may include a first chamber 51 that supplies the first slurry for forming the first composite layer 120, a second chamber 52 that supplies the second slurry for forming the first colored insulating layer 140, and a slot die 53 that applies the first slurry and the second slurry on the substrate 110 simultaneously or separately. The first slurry may include a positive electrode active material, a binder, or a conductive material. The second slurry may include a ceramic, a binder, or a pigment.

The second coating device 50 may apply the first slurry onto the substrate 110 by pressurizing the first chamber 51 to form the first composite layer 120 on the substrate 110. Simultaneously or additionally, the second coating device 50 may apply the second slurry onto the substrate 110 by pressurizing the second chamber 52 to form the first colored insulating layer 140 on the substrate 110.

For example, the second coating device 50 may form the first composite layer 120 and the first colored insulating layer 140 by using a Double Layer Slot Die Coating (DLD) method. The second coating device 50 may form the first colored insulating layer 141 to cover the initial end of the first composite layer 120 by applying the first slurry after the second slurry on one surface of the substrate 110. For example, the first coating device 50 may continuously form the first composite layer 120 in the first direction by blocking the supply of the second slurry, but applying the first slurry onto one surface of the substrate 110. For example, the second coating device 50 may form the first colored insulating layer 142 to cover the terminal end of the second composite layer 130 by applying the second slurry after the first slurry on one surface of the substrate 110.

The method for forming the first composite layer 120 and the first colored insulating layer 140 simultaneously as described above is only exemplary, but the present disclosure is not limited thereto.

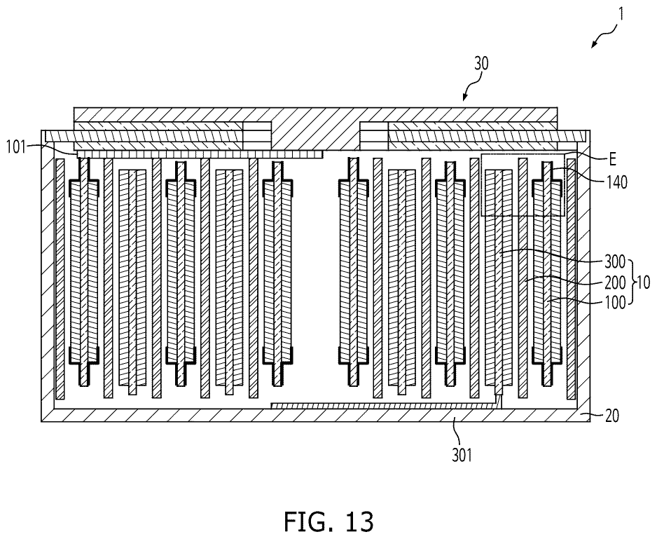

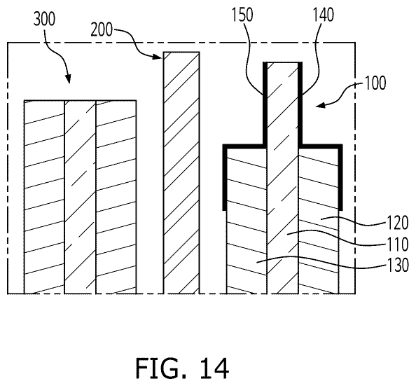

FIG. 13 is a view illustrating a secondary battery. FIG. 14 is an enlarged view of area E of FIG. 13.

A secondary battery 1 is not limited to the coil-type battery shown in FIG. 13.

Referring FIG. 13 and FIG. 14, the secondary battery 1 may include an electrode assembly 10 including a first electrode 100, a separator 200, and a second electrode 300, a case configured to accommodate the electrode assembly 10, and a cap assembly 30 coupled to the opening of a case 20 to seal the case 20.

The electrode assembly 10 may be a wound-type electrode assembly 10 formed by placing and winding the separator 200, which is an insulator, between the first electrode 100 and the second electrode 300. However, the present disclosure is not limited thereto, but the electrode assembly 10 may have a structure formed by stacking a plurality of first electrodes 100, separators 200, and second electrodes 300.

The first electrode 100 may function as a positive electrode. The first electrode 100 may include a substrate 110, a first composite layer 120, a second composite layer 130, a first colored insulating layer 140, and a second colored insulating layer 150.

The second electrode 300 may function as a negative electrode. The second electrode 300 may include a substrate formed of copper foil or nickel foil and a negative electrode active material layer coated on both surfaces of the substrate. The negative electrode active material layer may include, for example, graphite.

The electrode assembly 10 may include a first electrode tab 101 and a second electrode tab 301. The first electrode tab 101 may be separately formed and connected to a non-coated part of the first electrode 100, or may be formed by stamping a part of the non-coated part. The first electrode tab 101 may extend upwardly from the non-coated part to contact the cap assembly 30. However, the configuration where the first electrode tab 101 contacts the cap assembly 30 is only exemplary, but the present disclosure is not limited thereto. As the first electrode tab 101 contacts the cap assembly 30, the first electrode 100 may be electrically connected to the cap assembly 30.

The second electrode tab 301 may be separately formed and connected to a non-coated part of the second electrode 300 or may be formed by stamping a portion of the non-coated part. The second electrode tab 301 may extend downwardly from the non-coated part to contact the case 20. The configuration where the second electrode tab 301 contacts the case 20 is only exemplary, but the present disclosure is not limited thereto. As the second electrode 301 contacts the case 20, the second electrode 300 may be electrically connected to the case 20. The first electrode tab 101 may be electrically connected to the cap assembly 30, and the second electrode tab 301 is electrically connected to the case 20, but it is also possible that the first electrode tab 101 may be electrically connected to the case 20, and the second electrode tab 301 is electrically connected to the cap assembly 30, and the present disclosure is not limited thereto.

The case 20 may have one open side to accommodate the electrode assembly 10, and may be electrically connected to the second electrode 300. The case 20 may form the overall exterior of the secondary battery 1. For example, the case 20 may have an open cylindrical shape. The case 20 may include a circular lower surface and a side wall vertically extending from the circumference of the lower surface. The diameter of the lower surface of the case 20 may be greater than the height of the side wall, and the secondary battery 1 may be formed as a button-type or coin-type.

The cap assembly 30 may cover one open surface of the case 20 to seal the electrode assembly 10 from the outside. The cap assembly 30 may be electrically connected to the first electrode 100 of the electrode assembly 10.

As shown in FIG. 14, the first electrode 100 may have an area less than that of the second electrode 300. The separator 200 may be disposed between the first electrode 100 and the second electrode 300, but short-circuits may occur at end portions of the first electrode 100 and the second electrode 300. To prevent short-circuits, the first colored insulating layer 140 and the second colored insulating layer 150 may be formed on the substrate 110 of the first electrode 100 to cover both end portions of each of the first composite layer 110 and the second composite layer 130.

Although the present disclosure has been described with respect to embodiments thereof, the present disclosure is not limited thereto. Various modifications and variations can be made thereto by those skilled in the art within the spirit of the present disclosure.

### DESCRIPTION OF REPRESENTATIVE REFERENCE NUMERALS

1: Secondary Battery
10: Electrode Assembly
20: Case
30: Cap Assembly
40: First Coating Device
50: Second Coating Device
100: First Electrode
110: Substrate
120: First Composite layer
130: Second Composite Layer
140: First Colored Insulating Layer
150: Second Color Insulting Layer
200: Separator
300: Second Electrode

What is claimed is:

1. An electrode, comprising:
a substrate;
a first composite layer comprising an active material and disposed on a part of one surface of the substrate; and
a first colored insulating layer having a color different from the substrate and covers each end portion of the first composite layer.

2. The electrode as claimed in claim 1, wherein the first colored insulating layer comprises:
a first area covering from the end portion to a part of the first composite layer; and
a second area covering from the end portion to the part of the one surface of the substrate.

3. The electrode as claimed in claim 2, wherein a length of the second area is greater than about 0.5 mm.

4. The electrode as claimed in claim 1, wherein a thickness of the first colored insulating layer is greater than about 5 μm.

5. The electrode as claimed in claim 1, further comprising:
a second composite layer comprising the active material and disposed on a part of the other surface of the substrate; and
a second colored insulating layer having a color different from the substrate and covers each end portions of the second composite layer.

6. The electrode as claimed in claim 1, wherein the first colored insulating layer comprises a ceramic, a binder, or a pigment.

7. The electrode as claimed in claim 6, wherein the ceramic comprises boehmite or alumina.

8. The electrode as claimed in claim 6, wherein the binder comprises polyvinylidene fluoride, styrene butadiene rubber, acryl, polyamide, polyamideimide, or a copolymer thereof.

9. The electrode as claimed in claim 6, wherein the pigment comprises an organic pigment, an inorganic pigment, or a synthetic pigment.

10. The electrode as claimed in claim 1, wherein the first composite layer is continuous along a longitudinal direction of the substrate, and
wherein the first colored insulating layer is continuous along the longitudinal direction at each of the end portions of the first composite layer relative to a lateral direction of the substrate.

11. The electrode as claimed in claim 10, wherein the first composite layer comprises a plurality of first composite layers, and wherein each of the plurality of first composite layers are separated by a predetermined distance in the lateral direction.

12. The electrode as claimed in claim 1, wherein the first composite layer comprises a plurality of first composite layers, wherein each of the plurality of first composite layers are separated by a predetermined distance in the longitudinal direction.

13. The electrode as claimed in claim 12, wherein the first colored insulating layer is continuous along a lateral direction of the substrate from an initial end and a terminal end of the first composite layer relative to the longitudinal direction.

14. The electrode as claimed in claim 13, further comprising:
a second composite layer comprising the active material and disposed on a part of the other surface of the substrate; and
a second colored insulating layer having a color different from the substrate and covers each end portions of the second composite layer,
wherein the first composite layer and the second composite layer have different lengths in the longitudinal direction.

15. The electrode as claimed in claim 13, wherein the first colored insulating layer formed at the initial end and the first colored insulating layer formed at the terminal end have different lengths in the longitudinal direction.

16. The electrode as claimed in claim 13, wherein the first colored insulating layer is continuous along in the longitudinal direction between the initial end of one of the first composite layer and the terminal end of the at least one first composite layer adjacent to the one of the first composite layer.

17. A secondary battery, comprising:
an electrode assembly comprising a first electrode, a separator, and a second electrode;
a case accommodating the electrode assembly; and
a cap assembly coupled to an opening of the case,
wherein the first electrode comprises:
a substrate;
a first composite layer comprising an active material and disposed on a part of one surface of the substrate; and
a first colored insulating layer having a color different from the substrate and covers each end portion of the first composite layer.

18. The secondary battery as claimed in claim 17, wherein the first composite layer is continuous along a longitudinal direction of the substrate, and
wherein the first colored insulating layer is continuous along the longitudinal direction at each of the end portions of the first composite layer relative to a lateral direction of the substrate.

19. The secondary battery as claimed in claim 17, wherein the first composite layer comprises a plurality of first composite layers, and wherein each of the plurality of first composite layers are separated by a predetermined distance in the longitudinal direction.

20. The secondary battery as claimed in claim 19, wherein the first colored insulating layer is continuous along a lateral direction of the substrate from an initial end and a terminal end of the first composite layer relative to the longitudinal direction.
